(19) United States
(12) Patent Application Publication
(10) Pub. No.: US 2014/0342964 A1
(43) Pub. Date: Nov. 20, 2014

(54) POUCH COMPRISING A CLEANING COMPOSITION

(71) Applicant: The Procter & Gamble Company, Cincinnati, OH (US)

(72) Inventors: Michelle JACKSON, Gateshead (GB); Euan John MAGENNIS, Newcastle-upon-Tyne (GB)

(73) Assignee: The Procter & Gamble Company, Cincinnati, OH (US)

(21) Appl. No.: 14/277,161

(22) Filed: May 14, 2014

(30) Foreign Application Priority Data
May 14, 2013 (EP) 13167668.6

(51) Int. Cl. C11D 17/00; C11D 3/50

(52) U.S. Cl. CPC C11D 17/0039; C11D 3/50
USPC 510/106; 510/392; 510/102; 510/107; 510/101

(57) ABSTRACT

A pouch comprising a water-soluble film and a cleaning composition, the cleaning composition being at least partially encompassed within the water-soluble film, wherein the water-soluble film comprises at least 50% by weight of a water-soluble polyvinyl alcohol (PVOH) resin, the resin having an average viscosity in a range of 10 cP to 30 cP and a degree of hydrolysis in a range of 84% to 98%, and wherein the cleaning composition comprises an alpha-amylase with at least 90% identity with an alpha-amylase selected from the alpha-amylase of SEQ ID NO:1 and the alpha-amylase of SEQ ID NO:2.

### FIELD OF THE INVENTION

The present invention relates to a specific amylase with improved cold water properties and an effective way to deliver a cleaning composition comprising said amylase. The cleaning composition is encompassed in a pouch comprising water-soluble films having desired characteristics including good cold water-solubility, wet hand moisture resistance and mechanical properties.

### BACKGROUND OF THE INVENTION

Detergent consumer preferences tend towards colder wash temperatures and shorter wash times have resulted in the detergent formulators handling a whole series of different constraints. Consumers also want detergent products which are easy to dose and to manipulate as well as products to use at these lower wash temperatures and shorter wash times, with a similar performance as traditional higher wash temperatures and longer wash cycles; this is an extremely difficult consumer need to meet.

The detergent formulator must greatly improve the efficiency of the detergent ingredients, and of detergent composition as a whole. It is important to maintain good cleaning performance, stain removal performance, good odor profile, and good product stability.

The inventors have discovered that the combination in a pouch of a specific water-soluble film and of a cleaning composition comprising a specific amylase was providing excellent cleaning benefit in short wash time and at cold water temperature.

### SUMMARY OF THE INVENTION

The present invention concerns a pouch comprising a water-soluble film and a cleaning composition, the cleaning composition being at least partially encompassed within the water-soluble film. The water-soluble film comprises at least 50% by weight of a water-soluble polyvinyl alcohol (PVOH) resin, the resin having an average viscosity in a range of 10 cP to 30 cP and a degree of hydrolysis in a range of 84% to 98%. The cleaning composition comprises an alpha-amylase with at least 90% identity with an alpha-amylase selected from the alpha-amylase of SEQ ID NO:1 and the alpha-amylase of SEQ ID NO:2.

The use of a pouch comprising the water-soluble film of the invention is a particularly effective way to deliver the amylase of the invention in order to maximize the cleaning benefit of the cleaning composition. Also, the pouch form makes the cleaning product easy to use.

Unless specified otherwise, percentages and ratio are expressed in weight.

### BRIEF DESCRIPTION OF THE DRAWINGS

The present disclosure can be more readily understood with reference to the appended drawing figures where:

FIG. 1 is a perspective view of a test apparatus used to determine the water disintegration and dissolution times of film samples;

FIG. 2 is a perspective view of the test apparatus and test set-up illustrating the procedure for determining the water-solubility of film samples; and

FIG. 3 is a top view of the test set-up of FIG. 2.

### DETAILED DESCRIPTION OF THE INVENTION

### The Pouch

The pouch comprises a water-soluble film and a cleaning composition. The cleaning composition is at least partially encompassed within the water-soluble film. Preferably, the cleaning composition is fully encompassed within the water-soluble film.

The pouch may be a multi-compartment pouch. Each separate compartment of the pouch may comprise a same or different composition. This feature of the disclosure may be utilized to keep compositions containing incompatible ingredients (e.g., chelants and bleach with enzymes) physically separated or partitioned from each other. It is believed that such partitioning may expand the useful life and/or decrease physical instability of such ingredients. Additionally or alternatively, such partitioning may provide aesthetic benefits as described in European Patent Application Number 09161692.0 (filed Jun. 2, 2009 and assigned to the Procter & Gamble Company).

The pouch may be placed in packaging for storage and/or sale. In some embodiments, the package may be a see-through or partially see-through container, for example a transparent or translucent bag, tub, carton or bottle. The package may be made of plastic or any other suitable material, provided the material is strong enough to protect the pouch during transport. The package may comprise 2 or more pouches. This kind of pack is also very useful because the user does not need to open the pack to see how many pouches remain therein. Alternatively, the pack can have non-see-through outer packaging, perhaps with indicia or artwork representing the visually distinctive contents of the pack. In some embodiments, the package may provide at least a partial moisture barrier.

The pouch may be suitable for cleaning applications including, but not limited to cleaning laundry, dishes and the body (e.g. shampoo or soap). The pouch may be suitable for hand and/or machine washing conditions. When machine washing, the pouch may be delivered from a to dispensing drawer or may be added directly into the washing machine drum.

The pouch comprises at least one sealed compartment. The sealed compartment comprises the cleaning composition. The pouch may comprise a single compartment or multiple compartments. In embodiments comprising multiple compartments, each compartment may contain identical and/or different compositions. In turn, the compositions may take any suitable form including, but not limited to liquid, solid and combinations thereof (e.g. a solid suspended in a liquid). In some embodiments, the pouch comprises a first, second and third compartment, each of which respectively contains a different first, second and third composition. In some embodiments, the compositions may be visually distinct as described in European Patent Application Number 09161692.0 (filed Jun. 2, 2009 and assigned to the Procter & Gamble Company).

The compartments of multi-compartment pouches may be of the same or different size(s) and/or volume(s). The compartments of the present multi-compartment pouches can be separate or conjoined in any suitable manner. In some embodiments, the second and/or third and/or subsequent compartments are superimposed on the first compartment. In one embodiment, the third compartment may be superimposed on the second compartment, which is in turn superimposed on the first compartment in a sandwich configuration. Alternatively, the second and third compartments may be superimposed on the first compartment. However it is also equally envisaged that the first, second and optionally third and subsequent compartments may be attached to one another in a side by side relationship. The compartments may be packed in a string, each compartment being individually separable by a perforation line. Hence each compartment may be individually torn-off from the remainder of the string by the end-user, for example, so as to pre-treat or post-treat a fabric with a composition from a compartment.

In some embodiments, multi-compartment pouches comprise three compartments consisting of a large first compartment and two smaller compartments. The second and third smaller compartments are superimposed on the first larger compartment. The size and geometry of the compartments are chosen such that this arrangement is achievable. The geometry of the compartments may be the same or different. In some embodiments, the second and optionally third compartment each has a different geometry and shape as compared to the first compartment. In these embodiments, the second and optionally third compartments are arranged in a design on the first compartment. The design may be decorative, educative or illustrative, for example to illustrate a concept or instruction, and/or used to indicate origin of the product. In some embodiments, the first compartment is the largest compartment having two large faces sealed around the perimeter, and the second compartment is smaller, covering less than 75%, or less than 50% of the surface area of one face of the first compartment. In embodiments in which there is a third compartment, the aforementioned structure may be the same but the second and third compartments cover less than 60%, or less than 50%, or less than 45% of the surface area of one face of the first compartment.

The pouch may comprise one or more different films. For example, in single compartment embodiments, the pouch may be made from one wall that is folded onto itself and sealed at the edges, or alternatively, two walls that are sealed together at the edges. In multiple compartment embodiments, the pouch may be made from one or more films such that any given pouch compartment may comprise walls made from a single film or multiple films having differing compositions. In one embodiment, a multi-compartment pouch comprises at least three walls: an outer upper wall; an outer lower wall; and a partitioning wall.

The outer upper wall and the outer lower wall are generally opposing and form the exterior of the pouch. The partitioning wall is interior to the pouch and is secured to the generally opposing outer walls along a seal line. The partitioning wall separates the interior of the multi-compartment pouch into at least a first compartment and a second compartment.

Pouches may be made using any suitable equipment and method. For example, single compartment pouches may be made using vertical form filing, horizontal form filling or rotary drum filling techniques commonly known in the art. Such processes may be either continuous or intermittent. The film may be dampened, and/or heated to increase the malleability thereof.

The method may also involve the use of a vacuum to draw the film into a suitable mold. The vacuum drawing the film into the mold can be applied for 0.2 seconds to 5 seconds, or 0.3 seconds to 3 seconds, or 0.5 seconds to 1.5 seconds, once the film is on the horizontal portion of the surface. This vacuum can be such that it provides an under pressure of between 10 mbar to 1000 mbar, or from 100 mbar to 600 mbar, for example.

The molds, in which the pouches may be made, can have any shape, length, width and depth, depending on the required dimensions of the pouches. The molds may also vary in size and shape from one to another, if desirable. For example, the volume of the final pouches may be 5 ml to 300 ml, or 10 ml to 150 ml, or 20 ml to 100 ml, and that the mold sizes are adjusted accordingly.

Heat can be applied to the film in the process commonly known as thermoforming. The heat may be applied using any suitable means. For example, the film may be heated directly by passing it under a heating element or through hot air, prior to feeding it onto a surface or once on a surface. Alternatively it may be heated indirectly, for example by heating the surface or applying a hot item onto the film. In some embodiments, the film is heated using an infra red light. The film may be heated to a temperature of 50 to 150° C., 50 to 120° C., 60 to 130° C., 70 to 120° C., or 60 to 90° C.

Alternatively, the film can be wetted by any suitable means, for example directly by spraying a wetting agent (including water, solutions of the film material or plasticizers for the film material) onto the film, prior to feeding it onto the surface or once on the surface, or indirectly by wetting the surface or by applying a wet item onto the film.

Once a film has been heated and/or wetted, it may be drawn into an appropriate mold, preferably using a vacuum. The filling of the molded film can be accomplished utilizing by any suitable means. In some embodiments, the most preferred method will depend on the product form and required speed of filling. In some embodiments, the molded film is filled by in-line filling techniques. The filled, open pouches are then closed, using a second film, by any suitable method. This may be accomplished while in horizontal position and in continuous, constant motion. The closing may be accomplished by continuously feeding a second film, preferably water-soluble film, over and onto the open pouches and then preferably sealing the first and second film together, typically in the area between the molds and thus between the pouches.

Any suitable method of sealing the pouch and/or the individual compartments thereof may be utilized. Non-limiting examples of such means include heat sealing, solvent welding, solvent or wet sealing, and combinations thereof. Typically, only the area which is to form the seal is treated with heat or solvent. The heat or solvent can be applied by any method, typically on the closing material, and typically only on the areas which are to form the seal. If solvent or wet sealing or welding is used, it may be preferred that heat is also applied. Preferred wet or solvent sealing/welding methods include applying selectively solvent onto the area between the molds, or on the closing material, by for example, spraying or printing this onto these areas, and then applying pressure onto these areas, to form the seal. Sealing rolls and belts as described above (optionally also providing heat) can be used, for example.

The formed pouches may then be cut by a cutting device. Cutting can be accomplished using any known method. It may be preferred that the cutting is also done in continuous manner, and preferably with constant speed and preferably while in horizontal position. The cutting device can, for example, be a sharp item or a hot item, whereby in the latter case, the hot item burns' through the film/sealing area.

The different compartments of a multi-compartment pouch may be made together in a side-by-side style wherein the resulting, conjoined pouches may or may not be separated by cutting. Alternatively, the compartments can be made separately. In some embodiments, pouches may be made according to a process comprising the steps of:

a) forming a first compartment (as described above);

b) forming a recess within some or all of the closed compartment formed in step (a), to generate a second molded compartment superposed above the first compartment;

c) filling and closing the second compartments by means of a third film;

d) sealing the first, second and third films; and

e) cutting the films to produce a multi-compartment pouch.

The recess formed in step (b) may be achieved by applying a vacuum to the compartment prepared in step a).

In some embodiments, second, and/or third compartment(s) can be made in a separate step and then combined with the first compartment as described in WO 2009/152031 (filed Jun. 13, 2008 and assigned to the Procter & Gamble Company).

In some embodiments, pouches may be made according to a process comprising the steps of:

a) forming a first compartment, optionally using heat and/or vacuum, using a first film on a first forming machine;

b) filling the first compartment with a first composition;

c) on a second forming machine, deforming a second film, optionally using heat and vacuum, to make a second and optionally third molded compartment;

d) filling the second and optionally third compartments;

e) sealing the second and optionally third compartment using a third film;

f) placing the sealed second and optionally third compartments onto the first compartment;

g) sealing the first, second and optionally third compartments; and

h) cutting the films to produce a multi-compartment pouch

The first and second forming machines may be selected based on their suitability to perform the above process. In some embodiments, the first forming machine is preferably a horizontal forming machine, and the second forming machine is preferably a rotary drum forming machine, preferably located above the first forming machine.

It should be understood that by the use of appropriate feed stations, it may be possible to manufacture multi-compartment pouches incorporating a number of different or distinctive compositions and/or different or distinctive liquid, gel or paste compositions.

### the Water-Soluble Film

The water-soluble film described herein includes one or more polyvinyl alcohol (PVOH) polymers to make up the PVOH resin content of the film. One or a plurality of PVOH polymers may be selected or blended by the teachings herein to create a film, which is soluble in aqueous solutions. High molecular weight PVOH polymers offer comparatively good residual moisture resistance but are poorly soluble and difficult to thermoform, in part due to thermal sensitivity of the PVOH polymer. Low molecular weight PVOH polymers offer good cold water solubility but are too reactive to residual moisture to function in a commercial or consumer setting, and are difficult to thermoform, in part, due to pinholing and subsequent seepage when filled with liquids or gels. Polyvinyl alcohol is a synthetic resin generally prepared by the alcoholysis, usually termed hydrolysis or saponification, of polyvinyl acetate. Fully hydrolyzed PVOH, where virtually all the acetate groups have been converted to alcohol groups, is a strongly hydrogen-bonded, highly crystalline polymer which dissolves only in hot water—greater than about 60° C. If a sufficient number of acetate groups are allowed to remain after the hydrolysis of polyvinyl acetate, that is the PVOH polymer is partially hydrolyzed, then the polymer is more weakly hydrogen-bonded, less crystalline, and is generally soluble in cold water—less than 10° C. As such, the partially hydrolyzed polymer is a vinyl alcohol-vinyl acetate copolymer, that is a PVOH copolymer. Thus, one or more partially hydrolyzed PVOH copolymers are used in the water-soluble film.

The water-soluble film comprises at least 50% by weight of polyvinylalcohol (PVOH) resin comprising one or more PVOH polymers. The water soluble film comprises at least 50% by weight of polyvinylalcohol resin having an average viscosity in a range of 10 cP to 30 cP and a degree of hydrolysis in a range of 84% to 98%.

The water-soluble film may contain a total of at least 55 wt. %, 60 wt. %, 65 wt. %, 70 wt. %, 75 wt. %, 80 wt. %, 85 wt. %, 90 wt. % of PVOH polyvinylalcohol resin. The water-soluble film may comprise at least 60%, or 70%, for example at least 80% or 90% by weight of polyvinylalcohol resin having an average viscosity in a range of 10 cP to 30 cP and/or a degree of hydrolysis in a range of 84% to 98%.

The viscosity of a PVOH polymer ( ) is determined by measuring a freshly made solution using a Brookfield LV type viscometer with UL adapter as described in British Standard EN ISO 15023-2:2006 Annex E Brookfield Test method. It is international practice to state the viscosity of 4% aqueous polyvinyl alcohol solutions at 20° C. All viscosities specified herein in Centipoise (cP) should be understood to refer to the viscosity of 4% aqueous polyvinyl alcohol solution at 20° C., unless specified otherwise. Similarly, when a resin is described as having (or not having) a particular viscosity, unless specified otherwise, it is intended that the specified viscosity is the average viscosity for the resin, which inherently has a corresponding molecular weight distribution.

The water-soluble film may comprise at least 50% by weight of polyvinylalcohol resin having an average viscosity of at least 11 cP or 12 cP preferably of at least 13 cP or 14 cP, 15 cP, 16 cP, or 17 cP. The water soluble film may comprise at least 50% by weight of polyvinylalcohol resin having an average viscosity of at most 27 cP or 25 cP preferably of at most 20 cP, or 19 cP, or 17.5 cP. The water soluble film may comprise at least 50% by weight of polyvinylalcohol resin having an average viscosity in a range of 12 cP to 25 cP or 13.5 to 20 cP. The water-soluble film may comprises from 0% to 30% by weight of a PVOH polymer having an average viscosity less than 11 cP.

The weighted log viscosity average ( μ̅) of the polyvinylalcohol resin of the water-soluble film is calculated as follow. The μ̅ is calculated by the formula μ̅=e^{ΣW}^{ᵢ}^{·ln μ}^{_{μ}}where is the viscosity for the respective PVOH polymers and W is the weight fraction of the respective PVOH polymers.

The PVOH resin may include at least two PVOH polymers, wherein the first PVOH polymer has a viscosity less than the second PVOH polymer. A first PVOH polymer may have a viscosity of at least 8 cP, 10 cP, 12 cP, or 13 cP and at most 40 cP, 20 cP, 15 cP, or 13 cP, for example in a range of 8 cP to 40 cP, or 10 cP to 20 cP, or 10 cP to 15 cP, or 12 cP to 14 cP, or about 13 cP. Furthermore, a second PVOH polymer may have a viscosity of at least 10 cP, 20 cP, or 22 cP and at most 40 cP, 30 cP, 25 cP, or 24 cP, for example in a range of 10 cP to 40 cP, or 20 to 30 cP, or 20 to 25 cP, or 22 to 24, or about 23 cP.

It is well known in the art that the viscosity of PVOH resins is correlated with the weight average molecular weight ( M̅w) of the PVOH resin, and often the viscosity is used as a proxy for the M̅w. Therefore, teachings in the present disclosure regarding the effect of changes in the viscosity of the PVOH resin on the performance or characteristics of the water-soluble films, disclosed herein, correspondingly, apply to the effects of changes in the M̅w of the PVOH resin on the same properties.

The PVOH resin may include a PVOH polymer that has a M̅w in a range of 50,000 to 300,000 Daltons. The PVOH resin may include a first PVOH polymer that has a M̅w in a range of 50,000 to 300,000 Daltons, or 60,000 to 150,000 Daltons; and a second PVOH polymer that has a M̅w in a range of 60,000 to 300,000 Daltons, or 80,000 to 250,000 Daltons.

Depending on the PVOH polymer, the polydispersity index (PDI) of the resin may range from 1.5 to 5, or greater. The PDI of commercial PVOH polymers typically range from 1.8 to 2.3, and typical commercial PVOH polymers may have a PDI of as low as 1.7 and as high as 2.9. The PVOH resin for use herein may have a PDI value of at least 1.3, 1.5, 1.8, 2, 2.5, 3, and at most 6, 5.5, 5, 4.5, 4, 3.5, for example in a range of 1 to 5, or 2 to 4.5, or 2.5 to 4. The PDI value of the PVOH resin can be greater than the PDI value of any individual PVOH polymer included in the resin.

The water-soluble film may comprise at least 50% by weight of polyvinylalcohol resin having a degree of hydrolysis of at least 85% or 87% or 89%. The water-soluble film may comprise at least 50% by weight of polyvinylalcohol resin having a degree of hydrolysis of at most 96%, 94%, 92%, 91%, or 90%. For example, the water-soluble film comprises at least 50% by weight of polyvinylalcohol resin having a degree of hydrolysis in a range of 84% to 95%, or 85% to 91%. As used herein, the degree of hydrolysis is expressed as a percentage of vinyl acetate units converted to vinyl alcohol units.

The weight average degree of hydrolysis ( H̅°̅) of the polyvinylalcohol resin may be between 80 and 98%, or between 84 and 96%, or 87 and 91%. The H° is calculated by the formula H̅°̅=Σ(Wi·Hᵢ) where Wᵢ is the weight fraction of the respective PVOH polymers, and Hᵢ is the respective degrees of hydrolysis.

The individual PVOH polymers may have any suitable degree of hydrolysis, as long as the degree of hydrolysis of the total PVOH resin content is within the ranges of the invention.

The water-soluble film may comprise a PVOH resin that has a Resin Selection Index (RSI) in a range of 0.255 to 0.315, or 0.260 to 0.310, or 0.265 to 0.305, or 0.270 to 0.300, or 0.275 to 0.295, preferably 0.270 to 0.300. The RSI is calculated by the formula Σ(wᵢ|μᵢ=μₜ|)/93 (Wᵢμᵢ), wherein ₜ is seventeen, ᵢ is the average viscosity each of the respective PVOH polymers, and Wᵢ is the weight fraction of the respective PVOH polymers.

The water-soluble film preferably may be a free-standing film consisting of one layer or a plurality of like layers. The water-soluble-film may be thermoformable. The water-soluble film may further optionally consist essentially of the PVOH resin and the plasticizers and additives as described herein, and be essentially free of other film layers which would affect solubility, thermoforming performance, or both solubility and thermoforming performance.

The PVOH resin portion of the film may consist essentially of or consist entirely of PVOH polymers. The water-soluble film may also comprise film-forming polymers in addition to PVOH polymers. These additional polymers may be present in the film at a weight percentage of 0.1 to 40%, or at 1 to 30%, based on the total weight of the film. Non-limiting examples include starch, cellulosic materials, sulfopolyesters and mixtures thereof. Further non-limiting examples include: polyalkylene oxides, polyacrylic acid, polyvinyl pyrrolidone, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatin, natural gums such as xanthan, and carrageenans.

The water-soluble film may contain other auxiliary agents and processing agents, such as, but not limited to, plasticizers, lubricants, release agents, fillers, extenders, cross-linking agents, antiblocking agents, antioxidants, detackifying agents, antifoams, nanoparticles such as layered silicate-type nanoclays (e.g., sodium montmorillonite), bleaching agents (e.g., sodium bisulfite or others), and other functional ingredients, in amounts suitable for their intended purpose. Embodiments including plasticizers are preferred. The amount of such agents can be up to 50 wt. %, up to 20 wt %, or up to 15 wt %, or up to 10 wt %, or up to 5 wt. %, e.g., up to 4 wt %, individually or collectively.

The plasticiser may include, but is not limited to, glycerin, diglycerin, sorbitol, ethylene glycol, diethylene glycol, triethylene glycol, tetraethylene glycol, propylene glycol, polyethylene glycols up to 400 MW, neopentyl glycol, trimethylolpropane, polyether polyols, 2-methyl-1,3-propanediol, ethanolamines, and combinations thereof. Preferred plasticizers are glycerin, sorbitol, triethyleneglycol, propylene glycol, 2-methyl-1,3-propanediol, trimethylolpropane, and combinations thereof. The total amount of plasticizer may be in a range of 1 wt. % to 40 wt. %, or 10 wt. % to 40 wt. %, or 15 wt. % to 35 wt. %, or 20 wt. % to 30 wt. %, for example about 25 wt. %. Combinations of glycerin, propylene glycol, and sorbitol may be used. Optionally, glycerin can be used in an amount of 5 wt % to 30 wt %, or 5 wt % to 20 wt %, e.g., 13 wt %. Optionally, propylene glycol may be used in an amount of 1 wt. % to 20 wt. %, or 3 wt. % to 10 wt. %, e.g., about 6 wt. %. Optionally, sorbitol may be used in an amount of 1 wt % to 20 wt %, or 2 wt % to 10 wt %, e.g., 5 wt %.

The water-soluble film can further have a residual moisture content of at least 4 wt. %, for example in a range of 4 to 10 wt. %, as measured by Karl Fischer titration.

Embodiments of the invention include films that have the combined average degree of hydrolysis, weighted log average viscosity, and Resin Selection Index, as presented in the individual cells in Table I below.

TABLE I

| | μ̅ 13.5-20 | μ̅ 14-19 | μ̅ 15-18 | μ̅ 16-18 | μ̅ 17-18 | μ̅ 17.5 ± 0.5 |
|---|---|---|---|---|---|---|
| H̅°̅ 84-90 | H̅°̅ 84-90 | H̅°̅ 84-90 | H̅°̅ 84-90 | H̅°̅ 84-90 | H̅°̅ 84-90 | H̅°̅ 84-90 |
| | μ̅ 13.5-20 | μ̅ 14-19 | μ̅ 15-18 | μ̅ 16-18 | μ̅ 17-18 | μ̅ 17.5 ± 0.5 |
| | RSI 0.285 ± 0.15 | RSI 0.285 ± 0.15 | RSI 0.285 ± 0.15 | RSI 0.285 ± 0.15 | RSI 0.285 ± 0.15 | RSI 0.285 ± 0.15 |
| H̅°̅ 85-89 | H̅°̅ 85-89 | H̅°̅ 85-89 | H̅°̅ 85-89 | H̅°̅ 85-89 | H̅°̅ 85-89 | H̅°̅ 85-89 |
| | μ̅ 13.5-20 | μ̅ 14-19 | μ̅ 15-18 | μ̅ 16-18 | μ̅ 17-18 | μ̅ 17.5 ± 0.5 |
| | RSI 0.285 ± 0.15 | RSI 0.285 ± 0.15 | RSI 0.285 ± 0.15 | RSI 0.285 ± 0.15 | RSI 0.285 ± 0.15 | RSI 0.285 ± 0.15 |
| H̅°̅ 86-88 | H̅°̅ 86-88 | H̅°̅ 86-88 | H̅°̅ 86-88 | H̅°̅ 86-88 | H̅°̅ 86-88 | H̅°̅ 86-88 |
| | μ̅ 13.5-20 | μ̅ 14-19 | μ̅ 15-18 | μ̅ 16-18 | μ̅ 17-18 | μ̅ 17.5 ± 0.5 |
| | RSI 0.285 ± 0.15 | RSI 0.285 ± 0.15 | RSI 0.285 ± 0.15 | RSI 0.285 ± 0.15 | RSI 0.285 ± 0.15 | RSI 0.285 ± 0.15 |
| H̅°̅ 86.5 ± 0.5 | H̅°̅ 86.5 ± 0.5 | H̅°̅ 86.5 ± 0.5 | H̅°̅ 86.5 ± 0.5 | H̅°̅ 86.5 ± 0.5 | H̅°̅ 86.5 ± 0.5 | H̅°̅ 86.5 ± 0.5 |
| | μ̅ 13.5-20 | μ̅ 14-19 | μ̅ 15-18 | μ̅ 16-18 | μ̅ 17-18 | μ̅ 17.5 ± 0.5 |
| | RSI 0.285 ± 0.15 | RSI 0.285 ± 0.15 | RSI 0.285 ± 0.15 | RSI 0.285 ± 0.15 | RSI 0.285 ± 0.15 | RSI 0.285 ± 0.15 |

The water-soluble film may be formed by, for example, admixing, co-casting, or welding PVOH polymers. If the polymers are first admixed then the water-soluble film is preferably formed by casting the resulting admixture to form a film. If the polymers are welded, the water-soluble film may be formed by, for example, solvent or thermal welding.

The water-soluble film may have any suitable thickness. The water-soluble film may have a thickness between 20 μm and 125 μm, for example between 50 μm and 100 μm or between 65 μm and 85 μm.

The water-soluble film may have a Dissolution Index in a range of 620 to 920, or of 665 to 920, or of 710 to 920. The dissolution Index is measured on a sample of the film having a thickness of 76 μm.

The Dissolution Index of a film is derived by combining two physical characteristics which are the Dissolution Time and the Burst Strength.

Cold water-solubility is quantified as the Dissolution Time of a film. Dissolution Time is measured using the disclosed Slide Dissolution Test below.

Wet Hand Moisture Resistance is quantified by the sensitivity of a film to moisture and humidity, i.e. the film's wet-handling characteristics. Wet Hand Moisture Resistance is measured using the Burst Strength Test set forth below.

Since each of these parameters relate to different aspects of a consumer's experience, i.e., pouch residue on washed clothing and pouches sticking together due to contact with wet hands, to they are weighted differently in the equation utilized to Dissolution Index as defined in equation (1):

Dissolution Index=7*(Dissolution Time)+(Burst Strength) (1)

Mechanical properties of a film are quantified by its Stress at 100% Elongation and its Ultimate Tensile Strength. These quantities are measured utilizing the ASTM D 882, “Standard Test Method for Tensile Properties of Thin Plastic Sheeting”. These two film mechanical properties are combined to provide the Stress Index of a film as defined by the following equation (2):

Stress Index=(Stress at 100% Elongation)*(Ultimate Tensile Strength) (2)

The water-soluble film may have a Stress Index in a range of 145 to 626, or 155 to 480, or 165 to 325. The Stress Index is measured on a sample of the film having a thickness of 76 μm.

Without wishing to be bound by theory, it is believed that film having a Dissolution Index that is too high, i.e., above about 920, may provide for a pouch that incompletely dissolves during use. On the other hand, it is believed that a film having a Dissolution Index that is too low, i.e. less than about 620, may provide for a pouch that is too sensitive to moisture and humidity for the consumer market. Furthermore, it is believed that a film having a Stress Index that is too high, i.e., above about 626, may be difficult to process into a pouch due to difficulty in molding into a cavity. On the other hand, it is believed that a film having a Stress Index that is too low, i.e., less than about 145, may be susceptible to pinhole formation during processing into a pouch.

Suitable water-soluble films include M8630, or M8900 which are PVOH copolymer films available from MONOSOL. LLC, Merrillville, Ind. (USA).

### The Cleaning Composition

The cleaning compositions may comprise light duty or heavy duty liquid detergent compositions, hard surface cleaning compositions, fabric enhancers, detergent gels commonly used for laundry, bleach and laundry additives, shampoos, body washes, and other personal care compositions.

Cleaning compositions of use in the pouch may take the form of a liquid, solid or a powder. Liquid compositions may comprise a solid. Solids may include powder or agglomerates, to such as micro-capsules, beads, noodles or one or more pearlized balls or mixtures thereof. Such a solid element may provide a technical benefit, through the wash or as a pre-treat, delayed or sequential release component; additionally or alternatively, it may provide an aesthetic effect.

The cleaning composition comprises an alpha amylase. The cleaning composition may comprise one or more of the following non-limiting list of ingredients: fabric care benefit agent; detersive enzyme such as lipase, protease, peroxidase, another amylolytic enzyme, e.g., another alpha-amylase, glucoamylase, maltogenic amylase, CGTase, cellulase, mannanase (such as MANNAWAY™ from Novozymes, Denmark), pectinase, pectine lyase, cutinase, laccase, and mixtures thereof; deposition aid; rheology modifier; builder; bleach; bleaching agent; bleach precursor; bleach booster; bleach catalyst; perfume and/or perfume microcapsules (see for example U.S. Pat. No. 5,137,646); perfume loaded zeolite; starch encapsulated accord; polyglycerol esters;

whitening agent; pearlescent agent; enzyme stabilizing systems; scavenging agents including fixing agents for anionic dyes, complexing agents for anionic surfactants, and mixtures thereof; optical brighteners or fluorescers; polymer including but not limited to soil release polymer and/or soil suspension polymer; dispersants; antifoam agents; non-aqueous solvent; fatty acid; suds suppressors, e.g., silicone suds suppressors (see: U.S. Publication No. 2003/0060390 A1, 3/465-77); cationic starches (see: US 2004/0204337 A1 and US 2007/0219111 A1); scum dispersants (see: US 2003/0126282 A1, 3/489-90); dyes; colorants; opacifier; antioxidant; hydrotropes such as toluenesulfonates, cumenesulfonates and naphthalenesulfonates; color speckles; colored beads, spheres or extrudates; clay softening agents. Any one or more of these ingredients is further described in described in European Patent Application Number 09161692.0 (filed Jun. 2, 2009), U.S. Publication Number 2003/0139312A1 (filed May 11, 2000) and U.S. Patent Application No. 61/229981 (filed Jul. 30, 2009), each of which are assigned to the Procter & Gamble Company. Additionally or alternatively, the compositions may comprise surfactants and/or solvent systems, each of which is described below.

Alpha-Amylase

The cleaning composition of this invention comprises an alpha-amylase with at least 90%, preferably at least 95%, or at least 98%, or 99% or 100% identity with an alpha-amylase selected from the alpha-amylase of SEQ ID NO:1; and the alpha-amylase of SEQ ID NO:2.

The cleaning composition may comprise at least 0.01% or at least 0.02%, or from 0.05% to to 10%, or from 0.1% to 5% or from 0.2% to 2% of an alpha-amylase.

The alpha-amylase may have 100% identity with the alpha-amylase of SEQ ID NO:1; or SEQ ID NO:2. The alpha-amylase may distinguish from the alpha-amylase of SEQ ID NO:1; or SEQ ID NO:2 by at least 1 mutation, or by at least 2, or 3, or 5, or 10, or 15, or 20 mutations. The 1 or more mutation may occur at one or more of the following positions: 2, 7, 22, 25, 28, 29, 30, 35, 37, 53, 60, 70, 72, 75, 83, 87, 91, 93, 108, 116, 125, 126, 128, 129, 130, 131, 134, 136, 138, 142, 156, 160, 161, 165, 178, 182, 183, 185, 189, 192, 195, 197, 202, 210, 214, 217, 221, 234, 246, 269, 270, 279, 283, 298, 303, 305, 306, 310, 319, 320, 337, 340, 374, 375, 376, 379, 401, 407, 419, 433, 438, 453, 475, 476, and 483.

The alpha-amylase may distinguish from the alpha-amylase of SEQ ID NO:1 or SEQ ID NO:2 by at least 1 mutation, or by at least 2, or 3, or 5, or 10, or 15, or 20, or 30, or 40 mutations at one or more of the following positions: 7, 29, 35, 53, 60, 72, 87, 108, 116, 126, 128, 129, 130, 131, 134, 136, 138, 142, 156, 161, 165, 178, 182, 185, 189, 192, 195, 197, 202, 210, 214, 217, 221, 234, 246, 269, 303, 310, 337, 340, 374, 401, and 438.

The alpha-amylase may distinguish from the alpha-amylase of SEQ ID NO:1 or SEQ ID NO:2 by at least 1 mutation, or by at least 2, or 3, or 5, or 10, or 15, or 20, or 30, mutations at one or more of the following positions: 2, 7, 22, 25, 28, 30, 37, 70, 75, 83, 87, 91, 93, 108, 128, 160, 165, 178, 182, 183, 217, 269, 270, 279, 283, 298, 305, 306, 310, 320, 374, 375, 376, 407, 419, 475, and 476.

The alpha-amylase may distinguish from the alpha-amylase of SEQ ID NO:1 or SEQ ID NO:2 by at least 1 mutation, or by at least 2, or 3, or 5, or 10, or 15, or 20 mutations at one or more of the following positions: 83, 125, 128, 131, 160, 178, 182, 183, 185, 189, 279, 305, 319, 320, 379, 407, 433, 453, 475, 476, and 483.

The alpha-amylase may distinguish from the alpha-amylase of SEQ ID NO:1 or SEQ ID NO:2 by at least 1 mutation, or by at least 2, or 3, or 5 mutations selected from S125A, N128C, T131I, T165I, K178L, T182G, F202Y, S243Q, Y305R, D319T and G475K.

The alpha-amylase may distinguish from the alpha-amylase of SEQ ID NO:1 or SEQ ID NO:2 by at least a S243Q mutation.

The alpha-amylase may distinguish from the alpha-amylase of SEQ ID NO:1 or SEQ ID NO:2 by at least a S243Q and a G475K mutation. The alpha-amylase may distinguish from the alpha-amylase of SEQ ID NO:1 or SEQ ID NO:2 by at least a N128C, a K178L, a T182G, a Y305R, and a G475K mutation.

The alpha-amylase may distinguish from the alpha-amylase of SEQ ID NO:1 or SEQ ID NO:2 by at least a N128C, a K178L, a T182G, a F202Y, a S243Q, a Y305R, a D319T, and a G475K mutation. The alpha-amylase may distinguish from the alpha-amylase of SEQ ID NO:1) or SEQ ID NO:2 by at least a S125A, a N128C, a K178L, a T182G, a S243Q, a Y305R, and a G475K; mutation.

The alpha-amylase may distinguish from the alpha-amylase of SEQ ID NO:1 or SEQ ID NO:2 by at least a S125A, a N128C, a T131I, a T165I, a K178L, a T182G, a S243Q, a Y305R and a G475K mutation.

Suitable amylases according to the invention can be found in WO2010/115028 and WO2010/115021.

In addition to the alpha-amylase with at least 90%, identity with an alpha-amylase selected from the alpha-amylase of SEQ ID NO:1; and the alpha-amylase of SEQ ID NO:2, the cleaning composition may further comprise an additional amylase. The additional amylase may comprises an amylase with greater than 60% identity to the AA560 alpha amylase endogenous to Bacillus sp. DSM 12649, preferably a variant of the AA560 alpha amylase endogenous to Bacillus sp. DSM 12649 having:

(a) mutations at one or more of positions 9, 26, 149. 182, 186, 202, 257, 295, 299, 323, 339 and 345; and
(b) optionally with one or more, preferably all of the substitutions and/or deletions in the following positions: 118, 183, 184, 195, 320 and 458, which if present preferably comprise R118K, D183*, G184*, N195F, R320K and/or R458K.

Suitable commercially available additional amylase enzymes include Stainzyme® Plus, Stainzyme®, Natalase, Termamyl®, Termamyl® Ultra, Liquezyme® SZ (all Novozymes, Bagsvaerd, Denmark) and Spezyme® AA or Ultraphlow (DuPont®, Palo Alto, USA). The additional amylase may be in the form of granulates or liquids or mixtures thereof.

The alpha-amylase of the cleaning composition may comprise at least 10% or 30% or 50% or 70% or 90% by weight of alpha-amylase with at least 90%, identity with an alpha-amylase selected from the alpha-amylase of SEQ ID NO:1; and the alpha-amylase of SEQ ID NO:2.

The alpha-amylase of the cleaning composition may comprise from 10% to 90% or from to 30% to 70% of alpha-amylase with at least 90%, identity with an alpha-amylase selected from the alpha-amylase of SEQ ID NO:1; and the alpha-amylase of SEQ ID NO:2.

Surfactants:

The cleaning compositions may comprise surfactant, in particular from 1% to 80%, or from 5% to 50%, by weight of surfactant.

Surfactants may be of the anionic, nonionic, zwitterionic, ampholytic or cationic type or can comprise compatible mixtures of these types. More preferably surfactants are selected from the group consisting of anionic, nonionic, cationic surfactants and mixtures thereof. Detergent surfactants useful herein are described in U.S. Pat. No. 3,664,961, Norris, issued May 23, 1972, U.S. Pat. No. 3,919,678, Laughlin et al., issued Dec. 30, 1975, U.S. Pat. No. 4,222,905, Cockrell, issued Sep. 16, 1980, and in U.S. Pat. No. 4,239,659, Murphy, issued Dec. 16, 1980. Anionic and nonionic surfactants are preferred.

Useful anionic surfactants can themselves be of several different types. For example, water-soluble salts of the higher fatty acids, i.e., “soaps”, are useful anionic surfactants in the compositions herein. This includes alkali metal soaps such as the sodium, potassium, ammonium, and alkyl ammonium salts of higher fatty acids containing from about 8 to about 24 carbon atoms, and preferably from about 12 to about 18 carbon atoms. Soaps can be made by direct saponification of fats and oils or by the neutralization of free fatty acids. Particularly useful are the sodium and potassium salts of the mixtures of fatty acids derived from coconut oil and tallow, i.e., sodium or potassium tallow and coconut soap.

Additional non-soap anionic surfactants which are suitable for use herein include the water-soluble salts, preferably the alkali metal, and ammonium salts, of organic sulfuric reaction products having in their molecular structure an alkyl group containing from about 10 to about 20 carbon atoms and a sulfonic acid or sulfuric acid ester group. (Included in the term “alkyl” is the alkyl portion of acyl groups). Examples of this group of synthetic surfactants include: a) the sodium, potassium and ammonium alkyl sulfates, especially those obtained by sulfating the higher alcohols (C₈-C₁₈ carbon atoms) such as those produced by reducing the glycerides of tallow or coconut oil; b) the sodium, potassium and ammonium alkyl polyethoxylate sulfates, particularly those in which the alkyl group contains from 10 to 22, preferably from 12 to 18 carbon atoms, and wherein the polyethoxylate chain contains from 1 to 15, preferably 1 to 6 ethoxylate moieties; and c) the sodium and potassium alkylbenzene sulfonates in which the alkyl group contains from about 9 to about 15 carbon atoms, in straight chain or branched chain configuration, e.g., those of the type described in U.S. Pat. Nos. 2,220,099 and 2,477,383. Especially valuable are linear straight chain alkylbenzene sulfonates in which the average number of carbon atoms in the alkyl group is from about 11 to 13, abbreviated as C₁₁-C₁₃ LAS.

In some embodiments, the total anionic surfactant, i.e., soap and non-soap anionic, is present in the composition at a weight percentage of 1 wt % to 65 wt %, 2 wt % to 50 wt %, or 5 wt % to 45 wt %.

Preferred nonionic surfactants are those of the formula R₁(OC₂H₄)—OH, wherein R₁ is a C₁₀-C₁₆ alkyl group or a C₈-C₁₂ alkyl phenyl group, and n is from 3 to about 80. Particularly preferred are condensation products of C₁₂-C₁₅ alcohols with from about 5 to about 20 moles of ethylene oxide per mole of alcohol, e.g., C₁₂-C₁₃ alcohol condensed with about 6.5 moles of ethylene oxide per mole of alcohol.

The Solvent System:

The cleaning composition may comprise a solvent system. The solvent system may contain water, organic solvents and mixture thereof. Preferred organic solvents include 1,2-propanediol, ethanol, glycerol, dipropylene glycol, methyl propane diol and mixtures thereof. The cleaning composition may comprise less than 4% or less than 2% or less than 1% of water.

Other lower alcohols, C₁-C₄ alkanolamines such as monoethanolamine and triethanolamine, can also be used. Solvent systems can be absent, for example from anhydrous solid embodiments of the disclosure, but more typically are present at levels in the range of from about 0.1% to about 98%, preferably at least about 1% to about 50%, more usually from about 5% to about 25%.

Perfume:

The cleaning composition may comprise a perfume. The perfume may comprise a perfume comprising a mixture of at least 5 perfume raw materials and wherein the perfume comprises at least 25% or 35% or 45% or 55% or 65% or 75% or 85% by weight of perfume raw material selected from: Lavandin Grosso oil; Iso Propyl-2-Methyl Butyrate; Dimethyl cyclohexenyl 3-butenyl ketone; Eucalyptol; Benzyl Acetate; Hexyl Acetate; Methyl Benzoate; 3a,4,5,6,7,7a-hexahydro-4,7-methano-1H-indenyl acetate; Octanal; Cis-3 hexen-1-ol; Nonanal; Ethyl-2-methyl Butyrate; (Z,E)-2,4-dimethyl cyclohex-3-ene-1-carbaldehyde, Tetrahydro-4-methyl-2-(2-methyl propenyl)-2H-pyran; Geraniol; Iso propylbutanal; 2-pentylcyclopentan-1-ol; Dodecenal; d-limonene; Allyl Caproate; Decenal; Tetra Hydro Linalool; (E)-1-trimethyl-1-cyclohex-3(2,6,6-enyl)but-2-en-1-one; 2,4,6-trimethyl-3-cyclohexene-1-carboxaldehyde; Ionone Beta; Prenyl Acetate; 3-(4-tert-butylphenyl)propanal; 1 Carvone; Allyl Cyclohexyl Propionate; Linalool; Phenyl ethyl alcohol; Lemon Oil; Eugenol; Ethyl Vanillin; Cis-3-Hexenyl Acetate; Diphenyl Oxyde; Ionone Alpha; prop-2-enyl 2-cyclohexyloxyacetate; 2-pentyl-Cyclopentanone; Ethyl-2-methyl Pentanoate; [(4Z)-1-cyclooct-4-enyl]methyl carbonate; Cedryl Acetate; Cinnamic Alcohol; 2-methoxyethylbenzene; Phenyl Ethyl Phenyl Acetate; Citronellol; 2-tert-butyl cyclohexyl acetate; Citral; 3 alpha,4,5,6,7,7alpha-hexahydro-4,7-methano-1H-inden-6-yl propanoate; Iso-bornyl iso-butyrate; and mixture thereof.

The cleaning compositions may be prepared by mixing the ingredients together. If a pearlescent material is used it may be added in the late stages of mixing. If a rheology modifier is used, it is preferred to first form a pre-mix within which the rheology modifier is dispersed in a portion of the water and optionally other ingredients eventually used to comprise the compositions.

This pre-mix is formed in such a way that it forms a structured liquid. To this structured pre-mix can then be added, while the pre-mix is under agitation, the surfactant(s) and essential laundry adjunct materials, along with water and whatever optional detergent composition adjuncts are to be used.

The pH of the cleaning compositions may be from 4 to 12, from 5 to 11, from 6 to 10, from 6.5 to 8.5, or from 7.0 to 7.5. The cleaning composition may have a pH of from 8 to 10. The cleaning composition may have a pH of from 4 to 8.

The pH of the cleaning composition when liquid is defined as the pH of an aqueous 10% (weight/volume) solution of the detergent at 20° C. For solids and powdered cleaning composition this is defined as the pH of an aqueous 1% (weight/volume) solution of the detergent at 20° C.

### Test Methods

### Slide Dissolution Test:

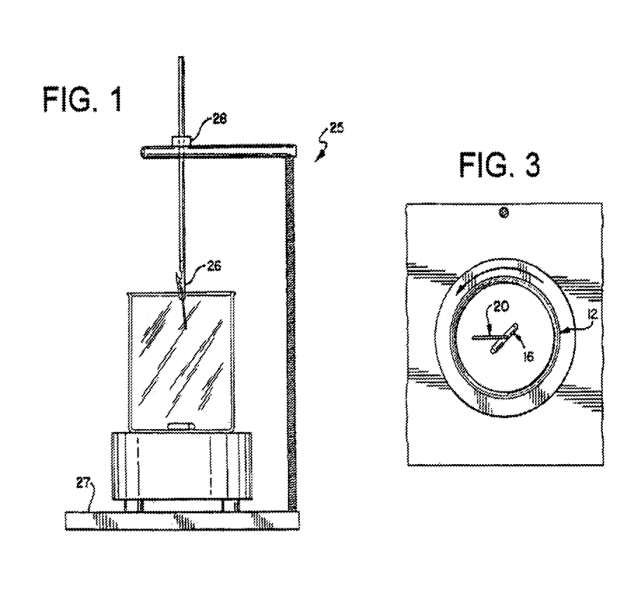

The MONOSOL Test Method 205 (MSTM 205) is disclosed with reference to appended FIGS. 1-3.

Apparatus and Materials:

### 600 mL Beaker 12

Magnetic Stirrer 14 (Labline Model No. 1250 or equivalent)

### Magnetic Stirring Rod 16 (5 cm)

### Thermometer (0 to 100° C., ±1° C.)

Template, Stainless Steel (3.8 cm×3.2 cm)
Timer, (0-300 seconds, accurate to the nearest second)
Polaroid 35 mm Slide Mount 20 (or equivalent)
MONOSOL 35 mm Slide Mount Holder 25 (or equivalent, see FIG. 1)

### Distilled Water

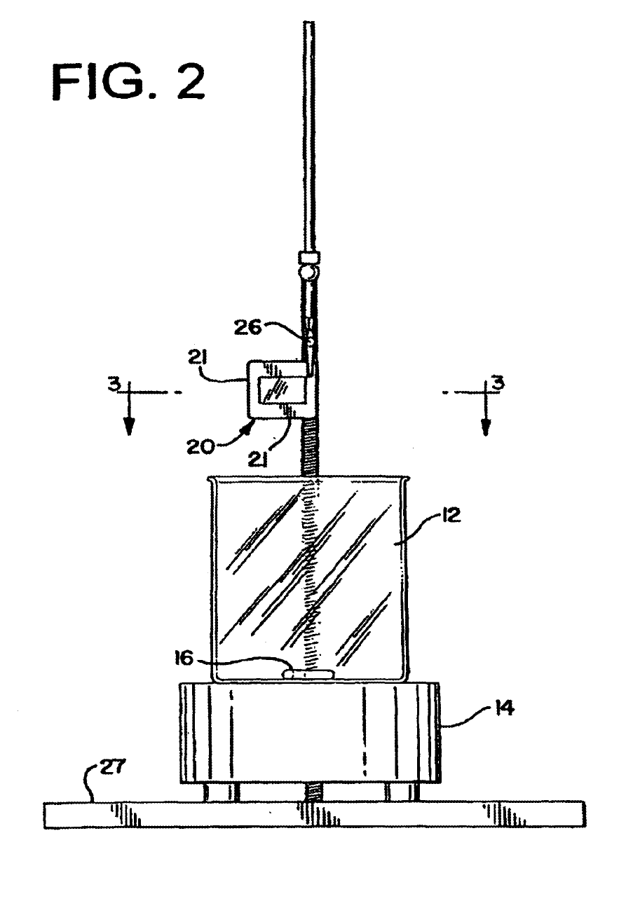

Test Specimen:
1. Cut three test specimens from film sample using stainless steel template (i.e., 3.8 cm×3.2 cm specimen). If cut from a film web, specimens should be cut from areas of web evenly spaced along the transverse direction of the web.
2. Lock each specimen in a separate 35 mm slide mount 20.
3. Fill beaker 12 with 500 mL of distilled water. Measure water temperature with thermometer and, if necessary, heat or cool water to maintain temperature at 10° C.
4. Mark height of column of water. Place magnetic stirrer 14 on base 27 of holder 25. Place beaker 12 on magnetic stirrer 14, add magnetic stirring rod 16 to beaker 12, turn on stirrer 14, and adjust stir speed until a vortex develops which is approximately one-fifth the height of the water column. Mark depth of vortex.
5. Secure the 35 mm slide mount 20 in the alligator clamp 26 of the MONOSOL 35 mm slide mount holder 25 (FIG. 1) such that the long end 21 of the slide mount 20 is parallel to the water surface, as illustrated in FIG. 2. The depth adjuster 28 of the holder 25 should be set so that when dropped, the end of the clamp 26 will be 0.6 cm below the surface of the water. One of the short sides 23 of the slide mount 20 should be next to the side of the beaker 12 with the other positioned directly over the center of the stirring rod 16 such that the film surface is perpendicular to the flow of the water, as illustrated in FIG. 3.
6. In one motion, drop the secured slide and clamp into the water and start the timer. Disintegration occurs when the film breaks apart. When all visible film is released from the slide mount, raise the slide out of the water while continuing to monitor the solution for undissolved film fragments. Dissolution occurs when all film fragments are no longer visible and the solution becomes clear.

Data Recording:

The results should include the following:
complete sample identification;
individual and average disintegration and dissolution times; and
water temperature at which the samples were tested.
The time for complete dissolution (in seconds) is obtained.

### Burst Strength Test:

A 4 l drop of deionized water obtained by reverse osmosis (at 23° C.) is placed on film region to be tested (at about 23° C. and an RH of about 25%) and clamped securely with a 2.5 pounds per square inch (“psig”) pressure compressed air behind the film. The droplet is gently placed in the center of the film's clamped circular exposed region which is 21 mm in diameter. The time between droplet placement and burst (i.e., the time at which the pressure is 2.0 psig or lower) is recorded. Film gauge is also recorded. The film region to be tested receives the droplet on its glossy side which forms the exterior surface of a typical pouch. Thus the glossy side of fresh or aged film receives the droplet in the present test.

### Stress at 100% Elongation Test:

The stress of a film at 100% elongation is measured utilizing the ASTM D 882, “Standard Test Method for Tensile Properties of Thin Plastic Sheeting”. The test is conducted on a Model 5544 Instron® Tensile Tester. The Instron® grips utilized in the test may impact the test results. Consequently, the present test is conducted utilizing Instron® grips having model number 2702-032 faces, which are rubber coated and 25 mm wide.

### Ultimate Tensile Strength Test:

The ultimate tensile strength is measured utilizing the ASTM D 882, “Standard Test Method for Tensile Properties of Thin Plastic Sheeting”. The test is conducted on a Model 5544 Instron® Tensile Tester. The Instron® grips utilized in the test may impact the test results. Consequently, the present test is conducted utilizing Instron® grips having model number 2702-032 faces, which are rubber coated and 25 mm wide.

### EXAMPLES

### Examples 1-5

Unit Dose Laundry detergent compositions of the present invention are provided below. Such unit dose formulations can comprise one or multiple compartments. In examples 1-5 the unit dose has one compartment, but similar compositions can be made with two, three, four or five compartments. The film used to encapsulate the cleaning composition is M8630 supplied by MonoSol®.

| | 1 | 2 | 3 | 4 | 5 |
|---|---|---|---|---|---|
| | (wt %) | (wt %) | (wt %) | (wt %) | (wt %) |
| Alkylbenzene sulfonic | 14.5 | 14.5 | 14.5 | 14.5 | 14.5 |
| acid | | | | | |
| C₁₂₋₁₈ alkyl ethoxy 3 | 7.5 | 7.5 | 7.5 | 7.5 | 7.5 |
| sulfate | | | | | |
| C₁₂₋₁₈ alkyl 7-ethoxylate | 13.0 | 13.0 | 13.0 | 13.0 | 13.0 |
| Citric Acid | 0.6 | 0.6 | 0.6 | 0.6 | 0.6 |
| Fatty Acid | 14.8 | 14.8 | 14.8 | 14.8 | 14.8 |
| *Amylase of the | 6.0 | 12.0 | 8.0 | 2.0 | 10.0 |
| invention (mg active) | | | | | |
| ** Amylase (mg active) | 6.0 | | 4.0 | 8.0 | |
| Ethoxylated | 4.0 | 4.0 | 4.0 | 4.0 | 4.0 |
| Polyethylenimine¹ | | | | | |
| Protease (Purafect | 1.4 | 2.0 | 0.9 | 1.2 | |
| Prime ®, 40.6 mg | | | | | |
| active/g) | | | | | |
| Hydroxyethane | 1.2 | 1.2 | 1.2 | 1.2 | 1.2 |
| diphosphonic acid | | | | | |
| Brightener | 0.3 | 0.3 | 0.3 | 0.3 | 0.3 |
| P-diol | 15.8 | 13.8 | 13.8 | 13.8 | 13.8 |
| Glycerol | 6.1 | 6.1 | 6.1 | 6.1 | 6.1 |
| MEA | 8.0 | 8.0 | 8.0 | 8.0 | 8.0 |
| TIPA | | | 2.0 | | |
| TEA | | 2.0 | | | |
| Cumene sulphonate | | | | | 2.0 |
| Cyclohexyl dimethanol | | | | 2.0 | |
| Water | 10 | 10 | 10 | 10 | 10 |
| Structurant | 0.14 | 0.14 | 0.14 | 0.14 | 0.14 |
| Perfume | 1.9 | 1.9 | 1.9 | 1.9 | 1.9 |

| | |
|---|---|
| Buffers | To pH 8.0 |
| (monoethanolamine) | |
| Solvents (1,2 | To 100% |
| propanediol, ethanol) | |

*Amylase of the present invention is shown as mgs of active enzyme per 100 g of detergent.
** Natalase ® Plus shown as active enzyme per 100 g of detergent.
¹Polyethylenimine (MW = 600) with 20 ethoxylate groups per —NH.

### Example 6-8

### Multiple Compartment Unit Dose Compositions

Multiple compartment unit dose laundry detergent formulations of the present invention are provided below. In these examples the unit dose has three compartments, but similar compositions can be made with two, four or five compartments. The film used to encapsulate the cleaning composition is M8630 supplied by MonoSol®.

| Base composition 6 | (wt %) |
|---|---|
| Glycerol (min 99) | 5.3 |
| 1,2-propanediol | 10.0 |
| Citric Acid | 0.5 |
| Monoethanolamine | 10.0 |
| Dequest 2010 | 1.1 |
| Potassium sulfite | 0.2 |
| *Amylase of this invention (mg active) | 10.0 |
| Nonionic Marlipal C₂₄EO₇ | 20.1 |
| HLAS | 24.6 |
| Optical brightener FWA49 | 0.2 |
| C₁₂₋₁₅ Fatty acid | 16.4 |
| Polymer Lutensit Z96 | 2.9 |
| Polyethyleneimine ethoxylate PEI600 E20 | 1.1 |
| MgCl₂ | 0.2 |
| Solvents (1,2 propanediol, ethanol) | To 100% |

| | Composition | | | | | |
|---|---|---|---|---|---|---|
| | 6A | | | 6B | | |
| Compartment | A | B | C | A | B | C |
| Volume of | 40 ml | 5 ml | 5 ml | 40 ml | 5 ml | 5 ml |
| each compart- | | | | | | |
| ment | | | | | | |
| Active material | | | | | | |
| in Wt. % | | | | | | |
| Perfume | 1.6 | 1.6 | 1.6 | 1.6 | 1.6 | 1.6 |
| Dyes | <0.01 | <0.01 | <0.01 | <0.01 | <0.01 | <0.01 |
| TiO2 | 0.1 | | | | 0.1 | |
| Sodium Sulfite | 0.4 | 0.4 | 0.4 | 0.3 | 0.3 | 0.3 |
| Acusol 305 | 1.2 | | | 2 | | |
| Hydrogenated | 0.14 | 0.14 | 0.14 | 0.14 | 0.14 | 0.14 |
| castor oil | | | | | | |
| Base | Add to | Add to | Add to | Add to | Add to | Add to |
| Composition 6 | 100% | 100% | 100% | 100% | 100% | 100% |

*Amylase of the present invention is shown as mgs of active enzyme per 100 g of detergent.

| Base composition 2 | (wt %) |
|---|---|
| Glycerol (min 99) | 5.3 |
| 1,2-propanediol | 10.0 |
| Citric Acid | 0.5 |
| Monoethanolamine | 10.0 |
| Dequest 2010 | 1.1 |
| Potassium sulfite | 0.2 |
| *Amylase of this invention (mg active) | 9.0 |
| **Amylase (mg active) | 5.0 |
| Protease (Purafect Prime ®, 40.6 mg | 2.0 |
| active/g) | |
| Nonionic Marlipal C24EO7 | 20.1 |
| HLAS | 24.6 |
| Optical brightener FWA49 | 0.2 |
| C12-15 Fatty acid | 16.4 |
| Polymer Lutensit Z96 | 2.9 |
| Polyethyleneimine ethoxylate PEI600 E20 | 1.1 |
| MgCl2 | 0.2 |
| Solvents (1,2 propanediol, ethanol) | To 100% |

| | Composition | | | | | |
|---|---|---|---|---|---|---|
| | 7A | | | 7B | | |
| Compartment | A | B | C | A | B | C |
| Volume of | 40 ml | 5 ml | 5 ml | 40 ml | 5 ml | 5 ml |
| each compart- | | | | | | |
| ment | | | | | | |
| Active material | | | | | | |
| in Wt. % | | | | | | |
| Perfume | 1.6 | 1.6 | 1.6 | 1.6 | 1.6 | 1.6 |
| Dyes | <0.01 | <0.01 | <0.01 | <0.01 | <0.01 | <0.01 |
| TiO2 | 0.1 | — | — | — | 0.1 | — |
| Sodium Sulfite | 0.4 | 0.4 | 0.4 | 0.3 | 0.3 | 0.3 |
| Acusol 305 | 1.2 | | | 2 | — | — |
| Hydrogenated | 0.14 | 0.14 | 0.14 | 0.14 | 0.14 | 0.14 |
| castor oil | | | | | | |
| Base | Add to | Add to | Add to | Add to | Add to | Add to |
| Composition 7 | 100% | 100% | 100% | 100% | 100% | 100% |

*Amylase of the present invention is shown as mgs of active enzyme per 100 g of detergent.
**Amylase such as Natalase ® Plus is shown as active enzyme per 100 g of detergent.

| Base composition 8 | (wt %) |
|---|---|
| Glycerol (min 99) | 5.3 |
| 1,2-propanediol | 10.0 |
| Citric Acid | 0.5 |
| Monoethanolamine | 10.0 |
| Dequest 2010 | 1.1 |
| Potassium sulfite | 0.2 |
| Nonionic Marlipal C₂₄EO₇ | 20.1 |
| HLAS | 24.6 |
| Optical brightener FWA49 | 0.2 |
| C₁₂₋₁₅ Fatty acid | 16.4 |
| Polymer Lutensit Z96 | 2.9 |
| Polyethyleneimine ethoxylate PEI600 E20 | 1.1 |
| MgCl₂ | 0.2 |
| Solvents (1,2 propanediol, ethanol) | To 100% |

| | Composition | | | | | |
|---|---|---|---|---|---|---|
| | 8A | | | 8B | | |
| Compartment | A | B | C | A | B | C |
| Volume of | 40 ml | 5 ml | 5 ml | 40 ml | 5 ml | 5 ml |
| each compart- | | | | | | |
| ment | | | | | | |
| Active material | | | | | | |
| in Wt. % | | | | | | |
| Perfume | 1.6 | 1.6 | 1.6 | 1.6 | 1.6 | 1.6 |
| Protease | | 0.5 | | | | 2.0 |
| (Purafect | | | | | | |
| Prime ®, 40.6 | | | | | | |
| mg active/g) | | | | | | |
| Dyes | <0.01 | <0.01 | <0.01 | <0.01 | <0.01 | <0.01 |
| *Amylase of | | | 3.0 | | 3.0 | |
| this invention | | | | | | |
| (mg active) | | | | | | |
| **Natalase ® | | | | | | |
| (mg active) | | | | | | |
| TiO2 | 0.1 | — | — | — | 0.1 | — |
| Sodium Sulfite | 0.4 | 0.4 | 0.4 | 0.3 | 0.3 | 0.3 |
| Acusol 305 | 1.2 | | | 2 | — | — |
| Hydrogenated | 0.14 | 0.14 | 0.14 | 0.14 | 0.14 | 0.14 |
| castor oil | | | | | | |
| Base | Add to | Add to | Add to | Add to | Add to | Add to |
| Composition 8 | 100% | 100% | 100% | 100% | 100% | 100% |

*Amylase of the present invention is shown as mgs of active enzyme per 100 g of detergent.
**active enzyme per 100 g of detergent.

### Examples 9-14

Pouches comprising granular laundry detergent compositions designed for hand washing or top-loading washing machines. The film used to encapsulate the cleaning composition is M8630 supplied by MonoSol®.

| | 9 | 10 | 11 | 12 | 13 | 14 |
|---|---|---|---|---|---|---|
| | (wt %) | (wt %) | (wt %) | (wt %) | (wt %) | (wt %) |
| Linear alkylbenzenesulfonate | 20 | 22 | 20 | 15 | 20 | 20 |
| C₁₂₋₁₄ Dimethylhydroxyethyl | 0.7 | 0.2 | 1 | 0.6 | | |
| ammonium chloride | | | | | | |
| AE₃S | 0.9 | 1 | 0.9 | | 0.5 | 0.9 |
| AE₇ | | | | 1 | 0.0 | 3 |
| Sodium tripolyphosphate | 5 | 0.0 | 4 | 9 | 2 | 0.0 |
| Zeolite A | | 1 | | 1 | 4 | 1 |
| 1.6R Silicate (SiO₂:Na₂O at | 7 | 5 | 2 | 3 | 3 | 5 |
| ratio 1.6:1) | | | | | | |
| Sodium carbonate | 25 | 20 | 25 | 17 | 18 | 19 |
| Polyacrylate MW 4500 | 1 | 0.6 | 1 | 1 | 1.5 | 1 |
| Random graft copolymer¹ | 0.1 | 0.2 | | | | |
| Carboxymethyl cellulose | 1 | 0.3 | 1 | 1 | 1 | 1 |
| Protease (Savinase ®, 32.89 mg | | 0.1 | 0.1 | 0.1 | | 0.1 |
| active/g) | | | | | | |
| Lipase - Lipex ® (18 mg active/g) | | 0.07 | 0.3 | 0.1 | 0.07 | 0.4 |
| *Amylase of the present | 0.63 | 1.0 | 2.0 | 0.44 | 0.88 | 0.3 |
| invention (mg active) | | | | | | |
| **Amylase (mg active) | | 1.0 | 0.5 | 0.7 | 0.15 | 0.3 |
| Fluorescent Brightener 1 | 0.06 | 0.0 | 0.06 | 0.18 | 0.06 | 0.06 |
| Fluorescent Brightener 2 | 0.1 | 0.06 | 0.1 | 0.0 | 0.1 | 0.1 |
| DTPA | 0.6 | 0.8 | 0.6 | 0.25 | 0.6 | 0.6 |
| MgSO₄ | 1 | 1 | 1 | 0.5 | 1 | 1 |
| Sodium Percarbonate | | 5.2 | 0.1 | | | |
| Sodium Perborate | 4.4 | | 3.85 | 2.09 | 0.78 | 3.63 |
| Monohydrate | | | | | | |
| NOBS | 1.9 | | 1.66 | | 0.33 | 0.75 |
| TAED | 0.58 | 1.2 | 0.51 | | 0.015 | 0.28 |
| Sulphonated zinc | 0.0030 | | 0.0012 | 0.0030 | 0.0021 | |
| phthalocyanine | | | | | | |
| S-ACMC | 0.1 | | | | 0.06 | |
| Direct Violet 9 | | | 0.0003 | 0.0005 | 0.0003 | |
| Acid Blue 29 | | | | | | 0.0003 |

| | |
|---|---|
| Sulfate/Moisture | Balance |

*Amylase of the present invention is shown as mgs of active enzyme per 100 g of detergent.
**Amylase such as Stainzyme ® Plus is shown as active enzyme per 100 g of detergent.

### Examples 15-20

Pouches comprising granular laundry detergent compositions designed for front-loading automatic washing machines. The film used to encapsulate the cleaning composition is M8630 supplied by MonoSol®.

| | 15 | 16 | 17 | 18 | 19 | 20 |
|---|---|---|---|---|---|---|
| | (wt %) | (wt %) | (wt %) | (wt %) | (wt %) | (wt %) |
| Linear alkylbenzenesulfonate | 8 | 7.1 | 7 | 6.5 | 7.5 | 7.5 |
| AE₃S | | 4.8 | | 5.2 | 4 | 4 |
| C₁₂₋₁₄ Alkylsulfate | 1 | | 1 | | | |
| AE₇ | 2.2 | | 3.2 | | | |
| C₁₀₋₁₂ Dimethyl | 0.75 | 0.94 | 0.98 | 0.98 | | |
| hydroxyethylammonium chloride | | | | | | |
| Crystalline layered silicate | 4.1 | | 4.8 | | | |
| (δ-Na₂Si₂O₅) | | | | | | |
| Zeolite A | 5 | | 5 | | 2 | 2 |
| Citric Acid | 3 | 5 | 3 | 4 | 2.5 | 3 |
| Sodium Carbonate | 15 | 20 | 14 | 20 | 23 | 23 |
| Silicate 2R (SiO₂:Na₂O at | 0.08 | | 0.11 | | | |
| ratio 2:1) | | | | | | |
| Soil release agent | 0.75 | 0.72 | 0.71 | 0.72 | | |
| Acrylic Acid/Maleic Acid | 1.1 | 3.7 | 1.0 | 3.7 | 2.6 | 3.8 |
| Copolymer | | | | | | |
| Carboxymethylcellulose | 0.15 | 1.4 | 0.2 | 1.4 | 1 | 0.5 |
| Protease - Purafect ® (84 mg | 0.2 | 0.2 | 0.3 | 0.15 | 0.12 | 0.13 |
| active/g) | | | | | | |
| Lipase - Lipex ® (18.00 mg | | 0.15 | 0.1 | | | |
| active/g) | | | | | | |
| Cellulase - Celluclean ™ (15.6 mg | | | | | 0.1 | 0.1 |
| active/g) | | | | | | |
| *Amylase of the present invention | 4.0 | 2.0 | 1.0 | 0.7 | 6.0 | 3.0 |
| (mg active) | | | | | | |
| **Amylase (mg active) | | 2.0 | | 3.0 | | 0.5 |
| TAED | 3.6 | 4.0 | 3.6 | 4.0 | 2.2 | 1.4 |
| Percarbonate | 13 | 13.2 | 13 | 13.2 | 16 | 14 |
| Na salt of Ethylenediamine-N,N′- | 0.2 | 0.2 | 0.2 | 0.2 | 0.2 | 0.2 |
| disuccinic acid, (S,S) isomer | | | | | | |
| (EDDS) | | | | | | |
| Hydroxyethane di phosphonate | 0.2 | 0.2 | 0.2 | 0.2 | 0.2 | 0.2 |
| (HEDP) | | | | | | |
| MgSO₄ | 0.42 | 0.42 | 0.42 | 0.42 | 0.4 | 0.4 |
| Perfume | 0.5 | 0.6 | 0.5 | 0.6 | 0.6 | 0.6 |
| Suds suppressor agglomerate | 0.05 | 0.1 | 0.05 | 0.1 | 0.06 | 0.05 |
| Soap | 0.45 | 0.45 | 0.45 | 0.45 | | |
| Sulphonated zinc phthalocyanine | 0.0007 | 0.0012 | 0.0007 | | | |
| (active) | | | | | | |
| S-ACMC | 0.01 | 0.01 | | 0.01 | | |
| Direct Violet 9 (active) | | | 0.0001 | 0.0001 | | |

| | |
|---|---|
| Sulfate/Water & Miscellaneous | Balance |

*Amylase of the present invention is shown as mgs of active enzyme per 100 g of detergent.
**Amylase such as Stainzyme ® Plus is shown as active enzyme per 100 g of detergent.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term to in a document incorporated by reference, the meaning or definition assigned to the term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A pouch comprising a water-soluble film and a cleaning composition, the cleaning composition being at least partially encompassed within the water-soluble film, wherein the water-soluble film comprises at least about 50% by weight of a water-soluble polyvinyl alcohol (PVOH) resin, the resin having an average viscosity in a range of about 10 cP to about 30 cP and a degree of hydrolysis in a range of about 84% to about 98%, and wherein the cleaning composition comprises an alpha-amylase with at least about 90% identity with an alpha-amylase selected from the alpha-amylase of SEQ ID NO:1 and the alpha-amylase of SEQ ID NO:2.

2. The pouch according to claim 1, wherein the alpha-amylase has at least about 98% identity with an alpha-amylase selected from the alpha-amylase of SEQ ID NO:1 and the alpha-amylase of SEQ ID NO:2.

3. The pouch according to claim 1, wherein water-soluble film comprises at least about 50% by weight of a water-soluble polyvinyl alcohol (PVOH) resin, the resin having an average viscosity in a range of about 12 cP to about 25 cP and a degree of hydrolysis in a range of 85% to 91%.

4. The pouch according to claim 1, wherein the material of the water-soluble film, having any suitable thickness, has a Dissolution Index in a range of about 620 to about 920 when the film has a thickness of about 76 microns, and a Stress Index in a range of about 145 to about 626, when the film has a thickness of about 76 microns.

5. The pouch according to claim 1, wherein the water-soluble film comprises from about 0% to about 30% by weight of a PVOH polymer having an average viscosity less than about 11 cP.

6. The pouch according to claim 1, wherein the PVOH resin comprises a first PVOH polymer having a viscosity in a range of about 8 cP to about 20 cP; and a second PVOH polymer having a viscosity in a range of about 20 cP to about 40 cP.

7. The pouch according to claim 1, wherein the water-soluble film further comprising about 1 wt. % to about 40 wt. % of a plasticizer.

8. The pouch of claim 1, wherein the plasticizer comprises a material selected from the group consisting of glycerin, sorbitol, propylene glycol, 2-methyl-1,3-propanediol, and a mixture thereof.

9. The pouch according to claim 1, wherein the water soluble film has a residual moisture content of about 4 wt. % to about 10 wt. %.

10. The pouch according to claim 1, wherein the water-soluble film having any suitable thickness, is characterized by having a Burst Strength of at least about 25 seconds, when the film has a thickness of about 76 microns.

11. The pouch according to claim 1, wherein the cleaning composition comprises a perfume comprising a mixture of at least 5 perfume raw materials and wherein the perfume comprises at least about 25 wt % of perfume raw material selected from: Lavandin Grosso oil; Iso Propyl-2-Methyl Butyrate; Dimethyl cyclohexenyl 3-butenyl ketone; Eucalyptol; Benzyl Acetate; Hexyl Acetate; Methyl Benzoate; 3a,4,5,6,7,7a-hexahydro-4,7-methano-1H-indenyl acetate; Octanal; Cis-3 hexen-1-ol; Nonanal; Ethyl-2-methyl Butyrate; (Z,E)-2,4-dimethyl cyclohex-3-ene-1-carbaldehyde, Tetrahydro-4-methyl-2-(2-methyl propenyl)-2H-pyran; Geraniol; Iso propylbutanal; 2-pentylcyclopentan-1-ol; Dodecenal; d-limonene; Allyl Caproate; Decenal; Tetra Hydro Linalool; (E)-1-trimethyl-1-cyclohex-3(2,6,6-enyl)but-2-en-1-one; 2,4,6-trimethyl-3-cyclohexene-1-carboxaldehyde; Ionone Beta; Prenyl Acetate; 3-(4-tert-butylphenyl)propanal; 1 Carvone; Allyl Cyclohexyl Propionate; Linalool; Phenyl ethyl alcohol; Lemon Oil; Eugenol; Ethyl Vanillin; Cis-3-Hexenyl Acetate; Diphenyl Oxyde; Ionone Alpha; prop-2-enyl 2-cyclohexyloxyacetate; 2-pentyl-Cyclopentanone; Ethyl-2-methyl Pentanoate; [(4Z)-1-cyclooct-4-enyl]methyl carbonate; Cedryl Acetate; Cinnamic Alcohol; 2-methoxyethylbenzene; Phenyl Ethyl Phenyl Acetate; Citronellol; 2-tert-butyl cyclohexyl acetate; Citral; 3alpha,4,5,6,7,7alpha-hexahydro-4,7-methano-1H-inden-6-yl propanoate; Iso-bornyl iso-butyrate; and mixture thereof.


SEQUENCE LISTING (2 sequences)

SEQ ID NO: 1 - protein, 583 aa, Bacillus sp. TS-23
NTAPINETMMQYFEWDLPNDGTLWTKVKNEAANLSSLGITALWLPPAYKGTSQSDVGYGVYDLYDLGEFNQKGTIRTKYGTKTQYIQAIQAAKAAGMQVYADVVFNHKAGADGTEFVDAVEVDPSNRNQETSGTYQIQAWTKFDFPGRGNTYSSFKWRWYHFDGTDWDESRKLNRIYKFRSTGKAWDWEVDTENGNYDYLMFADLDMDHPEVVTELKNWGTWYVNTTNIDGFRLDAVKHIKYSFFPDWLTYVRNQTGKNLFAVGEFWSYDVNKLHNYITKTNGSMSLFDAPLHNNFYTASKSSGYFDMRYLLNNTLMKDQPSLAVTLVDNHDTQPGQSLQSWVEPWFKPLAYAFILTRQEGYPCVFYGDYYGIPKYNIPGLKSKIDPLLIARRDYAYGTQRDYIDHQDIIGWTREGIDTKPNSGLAALITDGPGGSKWMYVGKKHAGKVFYDLTGNRSDTVTINADGWGEFKVNGGSVSIWVAKTSNVTFTVNNATTTSGQNVYVVANIPELGNWNTANAIKMNPSSYPTWKATIALPQGKAIEFKFIKKDQAGNVIWESTSNRTYTVPFSSTGSYTASWNVP

SEQ ID NO: 2 - protein, 484 aa, Bacillus sp. TS-23
NTAPINETMMQYFEWDLPNDGTLWTKVKNEAANLSSLGITALWLPPAYKGTSQSDVGYGVYDLYDLGEFNQKGTIRTKYGTKTQYIQAIQAAKAAGMQVYADVVFNHKAGADGTEFVDAVEVDPSNRNQETSGTYQIQAWTKFDFPGRGNTYSSFKWRWYHFDGTDWDESRKLNRIYKFRSTGKAWDWEVDTENGNYDYLMFADLDMDHPEVVTELKNWGTWYVNTTNIDGFRLDAVKHIKYSFFPDWLTYVRNQTGKNLFAVGEFWSYDVNKLHNYITKTNGSMSLFDAPLHNNFYTASKSSGYFDMRYLLNNTLMKDQPSLAVTLVDNHDTQPGQSLQSWVEPWFKPLAYAFILTRQEGYPCVFYGDYYGIPKYNIPGLKSKIDPLLIARRDYAYGTQRDYIDHQDIIGWTREGIDTKPNSGLAALITDGPGGSKWMYVGKKHAGKVFYDLTGNRSDTVTINADGWGEFKVNGGSVSIWVAK